(19) United States
(12) Patent Application Publication
(10) Pub. No.: US 2007/0039561 A1
(43) Pub. Date: Feb. 22, 2007

(54) Luminous Resilient Leash

(76) Inventor: Peter B. Tarlton, Red Bank, NJ (US)

Correspondence Address: PATTERSON & SHERIDAN L.L.P., 595 SHREWSBURY AVE, STE 100, FIRST FLOOR, SHREWSBURY, NJ, 07702, US

(21) Appl. No.: 11/464,368

(22) Filed: Aug. 14, 2006

Related U.S. Application Data
(60) Provisional application No. 60/707,592, filed on Aug. 12, 2005.

(51) Int. Cl. A01K 27/00

(52) U.S. Cl. 119/795

(57) ABSTRACT

In one embodiment, the invention is a luminous resilient leash. In one embodiment, the leash comprises an outer sheath formed of a resilient, substantially transparent or translucent material, and a luminous core housed within the sheath. In one embodiment, the luminous core comprises a gel medium and a phosphor powder suspended within the gel medium. In further embodiments, the invention is implemented in a luminous collar.

### CROSS REFERENCE TO RELATED APPLICATIONS

This application claims the benefit of U.S. Provisional Patent Application No. 60/707,592, filed Aug. 12, 2005, which is herein incorporated by reference in its entirety.

The present invention relates to generally pet accessories and relates more specifically to resilient pet leashes. Specifically, the invention is a luminous resilient leash.

### BACKGROUND OF THE DISCLOSURE

Leashes are commonly used to walk and/or tether pets such as dogs and cats, in order to prevent pets from wandering away from their owners while outdoors. Because it is often necessary to walk pets at times when it is dark outside, such as during the early morning or late evening or during inclement weather, luminous pet leashes are available that may be illuminated to alert others (such as motorists) to the presence of the pet and owner and/or to improve visibility for the pet and owner. Such leashes therefore double as a pet restraint means and as a safety precaution.

Typical luminous pet leashes comprise a transparent or translucent tube having a light source, such as a plurality of light emitting diodes (LEDs) or a light bulb and a bundle of optical fibers, housed therein. A problem with such leashes, however, is that while they provide adequate illumination, they are relatively inflexible, and thus the light source is not adequately protected against the mechanical shocks, stresses and stains associated with walking a pet (e.g., tensile stresses caused by a pet pulling against the leash). Moreover, the lack of flexibility can be a danger to the pet, as tension in the leash caused by a pulling pet may choke the pet or cause a great deal of discomfort in the area of the collar.

These same problems can be extended to other pet accessories such as collars, which are often used for identification and ownership purposes (e.g., as a fastening means for identification and/or registration tags).

Thus, there is a need for a luminous, resilient leash.

### SUMMARY OF THE INVENTION

In one embodiment, the invention is a luminous resilient leash. In one embodiment, the leash comprises an outer sheath formed of a resilient, substantially transparent or translucent material, and a luminous core housed within the sheath. In one embodiment, the luminous core comprises a gel medium and a phosphor powder suspended within the gel medium. In further embodiments, the invention is implemented in a luminous collar.

### BRIEF DESCRIPTION OF THE DRAWINGS

The teachings of the present invention can be readily understood by considering the following detailed description in conjunction with the accompanying drawings, in which:

FIG. 1 illustrates a plan view of a luminous, resilient leash, according to one embodiment of the present invention;

FIG. 2 illustrates a cross sectional view of the leash body illustrated in FIG. 1; and

FIG. 3 is a flow diagram illustrating a method for forming the body of a luminous, resilient leash (e.g., such as the leash illustrated in FIG. 1), according to one embodiment of the present invention.

To facilitate understanding, identical reference numerals have been used, where possible, to designate identical elements that are common to the figures.

### DETAILED DESCRIPTION

The present invention is a luminous, resilient leash, for example for use when walking a pet at night. The leash of the present invention is suitable for use in darkened conditions, where the ability of a pet and/or owner to see or be seen may be diminished. The novel leash is also suitable for use under load, for example due to the pulling or erratic motion of the pet.

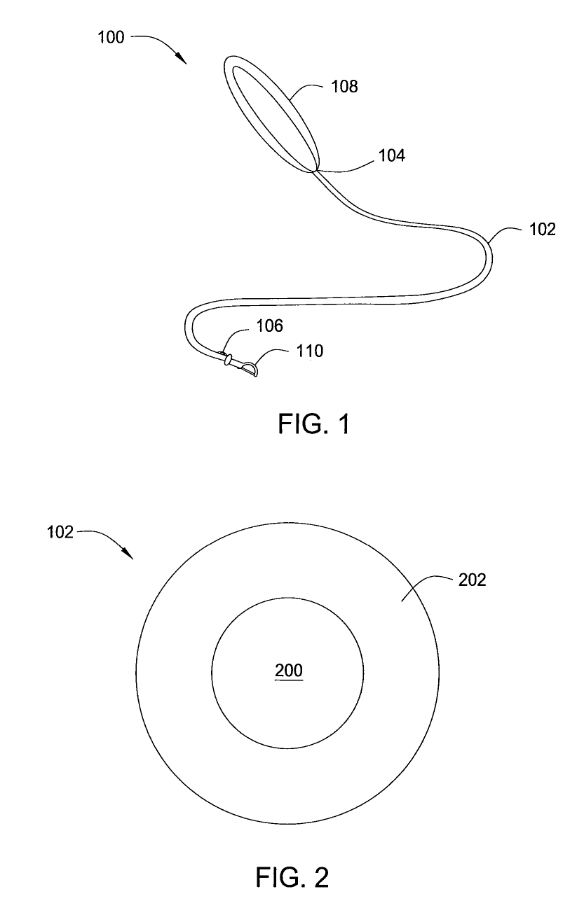

FIG. 1 illustrates a plan view of a luminous, resilient leash 100, according to one embodiment of the present invention. In one embodiment, the leash 100 comprises a body 102, a handle 108 and a fastening mechanism 110. The body 102 is substantially tubular and elongated in shape and has a first end 104 and a second end 106. The first end 104 of the body 102 is coupled to the handle 108. In one embodiment, the handle 108 comprises a loop of material (e.g., the same material as the body 102) adapted to allow a user to securely grasp the leash 100. In another embodiment, the handle 108 may be joined to the body 102 by a swivel or similar attachment mechanism that facilitates movement and/or rotation of the leash 100 (e.g., similar to a surfboard leash connection). In another embodiment, the handle 108 may have any configuration and be made of any material that allows the user to grasp the leash 100 and/or allow movement or rotation of the leash 100.

The second end 106 of the leash body 102 is coupled to the fastening mechanism 110. The fastening mechanism 110 is adapted for fastening the leash 100, for example to a pet (e.g., by fastening to a collar worn by the pet). In one embodiment, the fastening mechanism 110 is a spring-loaded clip. In alternate embodiments, the fastening mechanism 110 may be any mechanism that allows the leash 100 to be securely and comfortably fastened. In another embodiment, the fastening mechanism 110 may comprise an adjustable loop of material similar to a pet collar.

FIG. 2 is a cross sectional view of the leash body 102 illustrated in FIG. 1. As illustrated, the leash body 102 comprises a luminous core 200 and a resilient sheath 202 surrounding the core 200. In one embodiment, the core 200 is a luminous gel suspended within the sheath 202. In one embodiment, the gel comprises a phosphor powder suspended within a viscous gel medium, as described in further detail below.

The sheath 202 substantially surrounds the core 200 and comprises a resilient material adapted to absorb mechanical shocks, stresses and strains, such as those associated with walking a pet. In one embodiment, the sheath 202 serves two primary functions: (1) to protect the pet against choking and/or discomfort; and (2) to retain the viscous gel of the core 200 so that the gel does not leak. In one embodiment, the sheath 202 has approximately a five percent elasticity, which accommodates control with shock absorption. In one embodiment, the sheath 202 comprises a tube formed from a substantially transparent or translucent elastomeric or polymer material such as at least one of: urethane, polyurethane (e.g., having an ether/ester base resin), nylon, polytetrafluoroethylene (PTFE), flexible polyvinyl chloride (FPVC), low-density polyethylene (LDPE), a fluoropolymer such as polyvinylidine fluoride (PVDF), ethyl vinyl acetate (EVA) or polyester, among other materials. In another embodiment, the sheath 202 comprises an internally coated tubing (e.g., similar to an optical fiber), where the tubing is coated with the gel medium. In other embodiments, the sheath 202 may be formed from any material that provides adequate resiliency to protect the core 200 and the pet, and that is transparent enough to allow substantially 360 degree radiant light dispersion (from the core 200) therethrough.

The luminous, resilient leash 100 of the present invention is thus both sufficiently resilient to protect the pet and mechanically robust to substantially prevent failure. The use of a luminous gel as the core 200 of the leash 100 enables the core 200 to be at least as resilient as the sheath 202 surrounding the core 200, so that the failure rate associated with mechanical light-emitting mechanisms is substantially reduced. Moreover, in embodiments where phosphor powder is used to provide luminescence in the core 200, the leash 100 may be re-energized so that the leash 100 can be used over time with little observable diminishment of the leash's radiant properties (e.g., utilizing the Tyndall effect).

It will be appreciated that the leash of the present invention need not necessarily be used only to restrain pets. Moreover, as discussed above, the concept of luminous gel housed within a resilient sheath may be applied to pet accessories other than leashes, including collars, to further utilize the advantages of the present invention.

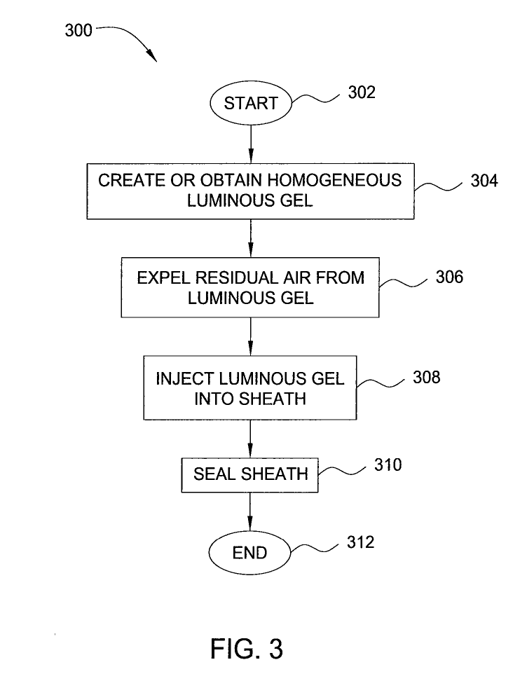

FIG. 3 is a flow diagram illustrating a method 300 for forming the body 102 of a luminous, resilient leash (e.g., such as the leash 100 of FIG. 1), according to one embodiment of the present invention. The method 300 is initialized at step 302 and proceeds to step 304, where a substantially homogeneous luminous gel medium is either obtained or created, e.g., to form the core 200 of the body 102. In one embodiment, the luminous gel is a phosphor gel comprising a phosphor powder suspended in a viscous, non-toxic gel medium. In one embodiment, the luminous gel contains at least approximately 0.5 grams of phosphor powder for approximately every one liquid ounce of gel medium.

In one embodiment, the phosphor powder has luminous properties sufficient to achieve substantially 360 degree radiant light dispersion, and in one embodiment, the phosphor powder comprises at least one of: strontium, yttrium, calcium or nano-phosphor (i.e., particulate approximately the size of a phosphor crystal). In one embodiment, the gel medium has a viscosity that is sufficient to suspend the phosphor powder in a substantially homogenous and permanent manner (e.g., to prevent the phosphor powder from settling). In one embodiment, the gel medium comprises at least one of: a polyacrylamide (e.g., water-absorbing) acrylic, a cross-linked polymer, a mineral oil (e.g., with modified and stabilized viscosity), a hydrogel or cured silicone (which is substantially self-sealing).

In one embodiment, where the luminous gel is created from raw materials, homogenous dispersion of the phosphor powder within the gel medium is accomplished using stirring rods to mix the raw materials. The use of stirring rods substantially reduces the shearing and/or crushing of the phosphor powder crystals during mixing.

In step 306, residual air (e.g., in voids) is expelled from the luminous gel. In one embodiment, residual air is expelled by compressing the luminous gel to vent the air. In another embodiment, residual air is expelled by compacting the luminous gel, e.g., within a centrifuge, to vent the air. In yet another embodiment, the luminous gel may be both compressed and compacted within a centrifuge to further ensure that air is substantially eliminated from the luminous gel.

In step 308, the luminous gel mixture is injected into the sheath 202. In one embodiment, injection of the luminous gel is performed under pressure, with the sheath being disposed vertically so that gravity aids in compressing the luminous gel within the sheath 202 and in reducing or eliminating air voids within the sheath 202.

In step 310, the sheath 202 is sealed at both ends 104 and 106 of the body 102 to prevent the luminous gel from escaping or leaking. Alternatively, if the luminous gel is cured or self-sealing, the sheath 202 is simply cut to length. In one embodiment, at least one of the first or second end 104 or 104 is mechanically sealed. In another embodiment, at least one of the first or second end 104 or 104 is heat sealed. The method 300 is then terminated in step 312.

Those skilled in the art will appreciate that an apparatus constructed in accordance with the present invention may have uses in fields other than pet accessories and products, including, but not limited to, toys, sporting goods and accessories (e.g., bicycle accessories), maritime equipment and accessories and other items.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A leash, comprising:
a resilient sheath; and
a luminous core housed within the sheath, the luminous core comprising:
a gel medium; and
a phosphor powder suspended within the gel medium.

2. The leash of claim 1, wherein the sheath comprises a tube formed from at least one of: a substantially transparent elastomer, a substantially translucent elastomer, a substantially transparent polymer or a substantially translucent polymer.

3. The leash of claim 2, wherein the sheath is formed from at least one of: urethane, polyurethane, nylon, polytetrafluoroethylene, polyvinyl chloride, polyethylene, polyvinylidine fluoride, ethyl vinyl acetate or polyester.

4. The leash of claim 2, wherein an interior surface of the tube is coated.

5. The leash of claim 1, wherein the core comprises at least approximately 0.5 grams of phosphor powder for approximately every one liquid ounce of gel medium.

6. The leash of claim 1, wherein the phosphor powder comprises at least one of: strontium, yttrium, calcium or nano-phosphor.

7. The leash of claim 1, wherein the gel medium comprises at least one of: polyacrylamide acrylic, cross-linked polymer, mineral oil, hydrogel or cured silicone.

8. The leash of claim 1, wherein the sheath and core form a substantially tubular, elongated body having a first end and a second end.

9. The leash of claim 8, further comprising:
a handle coupled to the first end and configured to allow a user to grasp the pet leash; and
a fastening mechanism coupled to the second end and configured to fasten the pet leash to a pet.

10. A method for forming a body of a leash, the method comprising:
obtaining a luminous gel, the gel comprising a phosphor powder suspended within a gel medium; and
injecting the gel into a resilient sheath.

11. The method of claim 10, further comprising:
expelling residual air from the gel prior to injecting the gel into the sheath.

12. The method of claim 10, further comprising:
allowing the gel to self-seal; and
cutting the sheath to length.

13. The method of claim 10, wherein the injecting is performed under pressure.

14. The method of claim 10, the sheath comprises a tube formed from at least one of: urethane, polyurethane, nylon, polytetrafluoroethylene, polyvinyl chloride, polyethylene, polyvinylidine fluoride, ethyl vinyl acetate or polyester.

15. The method of claim 10, wherein the phosphor powder comprises at least one of: strontium, yttrium, calcium or nano-phosphor.

16. The method of claim 10, wherein the gel medium comprises at least one of: polyacrylamide acrylic, cross-linked polymer, mineral oil, hydrogel or cured silicone.

17. The method of claim 10, further comprising:
coupling a handle coupled to a first end of the body, the handle being configured to allow a user to grasp the leash; and
coupling a fastening mechanism to a second end of the body, the fastening mechanism being configured to fasten the leash.
